(19) United States
(12) Patent Application Publication
(10) Pub. No.: US 2011/0173240 A1
(43) Pub. Date: Jul. 14, 2011

(54) MEDIA COLLECTION MANAGEMENT

(76) Inventors: Gregory R. Bryniarski, Rochester, NY (US); Lawrence B. Landry, Victor, NY (US)

(21) Appl. No.: 12/972,587

(22) Filed: Dec. 20, 2010

Related U.S. Application Data
(60) Provisional application No. 61/293,310, filed on Jan. 8, 2010.

(51) Int. Cl. G06F 17/30

(52) U.S. Cl. 707/822; 707/E17.01

(57) ABSTRACT

A removable storage device (204) includes a memory and management software that includes prioritization criteria for determining which files stored in the memory should be transferred to an external device such as a digital picture frame (206). In another embodiment, a system for media collection management includes a computer having a storage area for storing media files, and first and second display devices in communication with the computer. Media management software stored in the storage area includes prioritization criteria for determining which of the media files need to be transferred to the first and second display devices.

### CROSS REFERENCE TO RELATED APPLICATIONS

This application claims the benefit of U.S. Provisional Patent Application No. 61/293,310, filed Jan. 8, 2010, which is incorporated herein by reference in its entirety.

### FIELD OF THE INVENTION

This invention relates in general to a method and system for managing a data collection such as an image/video collection.

### BACKGROUND OF THE INVENTION

One-way file synchronization between a personal computer (PC) and a portable computing device such as personal digital assistant (PDA) using file synchronization software allows a user to synchronize files between the PC and the PDA. Similarly, data mirroring used for backup of files to a back up storage media allows a user to preselect directories that will be backed up and all files in the selected directories are backed up. One problem with the above mentioned data management techniques is that the transfer of the data requires synchronization which requires all files in one device to be transferred to the other device or all files within a directory to be transferred. These techniques force files that are not needed to be transferred which take up valuable memory storage area.

### BRIEF DESCRIPTION OF THE DRAWINGS

FIG. 1 shows a flow chart in accordance with an embodiment of the invention.

FIG. 2 shows a system in accordance with an embodiment of the invention.

FIG. 3 shows a removable storage device, showing listings of what is stored in each of the PC, DPF #1 and DPF #2 in accordance with an embodiment of the invention.

FIG. 4 shows a block diagram of the removable storage device in accordance with an embodiment of the invention.

FIG. 5 shows a media collection management system in accordance with an embodiment of the invention.

FIG. 6 shows a flowchart highlighting some of the steps in providing media collection management in accordance with an embodiment of the invention.

### DETAILED DESCRIPTION OF THE INVENTION

In one embodiment of the invention, a removable storage device is used as the transport mechanism between one device, i.e., a computer such as a personal computer (PC), and one or more electronic display devices such as a digital picture frames (DPFs), tablet computer, etc. The removable storage device in one embodiment can be a memory dongle such as a USB stick, portable hard drive, removable memory card such as an SD memory card, or other similar memory storage device as know in the art. In accordance with an embodiment of the invention, the removable storage device includes a “Virtual Frame” (VF) software application that accomplishes the transfer of data such as images, videos, etc. in a two step process. First retrieving data such as an image from the PC and then transferring it from the removable storage device to one or more of the DPFs or vice-versa (DPF to removable storage device to PC). Synchronization of data/media (pictures, videos, etc.) is “open-loop” so all the files on the DPF are not necessarily identical to those found in the PC. In other words, there does not have to be complete file synchronization between the devices (PC, DPFs). Also, not all files within a directory for example are necessarily transferred. Transfers depend in part on available space in both the transfer media and the target device(s), as well as the importance of the file(s).

It is also possible that the DPF may not be able to store all of the content that may be available on the PC given for example differences in memory capacity so the content can be prioritized using a prioritization criteria in accordance with an embodiment of the invention such as by using file size, user rating (“number of stars”), content having user entered metadata but no user rating having a higher priority than content with no user rating and no metadata having been entered by the user, age of data/image, still image versus video, any other meta-data associated with the picture or video, etc. as a prioritization criteria for determining which files are to be stored and/or deleted from the DPF or PC.

In another embodiment, the removable storage device can include a file listing of the media found in the PC as well as every electronic device such as DPF in the system. For example, if a user has multiple display devices in his house, the portable storage device can store information on all the display devices in the system. So the removable storage device can keep track of what media is available in each of the devices in the system. The removable media can also keep in its listings information on memory capacity (i.e., available capacity) for each of the display devices such as digital picture frames and the PC. In some scenarios, a priority ranking scheme using the prioritization criteria mentioned above can be used to decide which missing media can be stored in each DPF in the case as an illustrative example, where the DPF cannot store all of the missing media that is located in the PC. In another embodiment, the VF software can automatically, using the prioritization criteria load missing media into one or more of the DPFs based on the information it has stored regarding available memory in each DPF (or PC) as well as the prioritization criteria it is using.

The prioritization criteria can be determined (established) by a system user prior to starting to use the removable media, by for example connecting the removable media to a PC and an auto executing program found in the removable media presenting prioritization criteria choices to the user, and the user ranking the choices depending on what the user prioritization criteria may be. For example, a particular user might decide that videos are more important than still images so the user may set the prioritization such that videos, if memory is available, in a particular DPF are loaded first over still images, etc. In another example, a user may use the “age” of an image and/or video as the more important prioritization criteria such that “newer” images/videos are uploaded to a DPF or a PC prior to older images/videos. The age of an image/video may be stored as metadata associated with a particular image/video and the VF software reads this information in order to prioritize the images/videos accordingly.

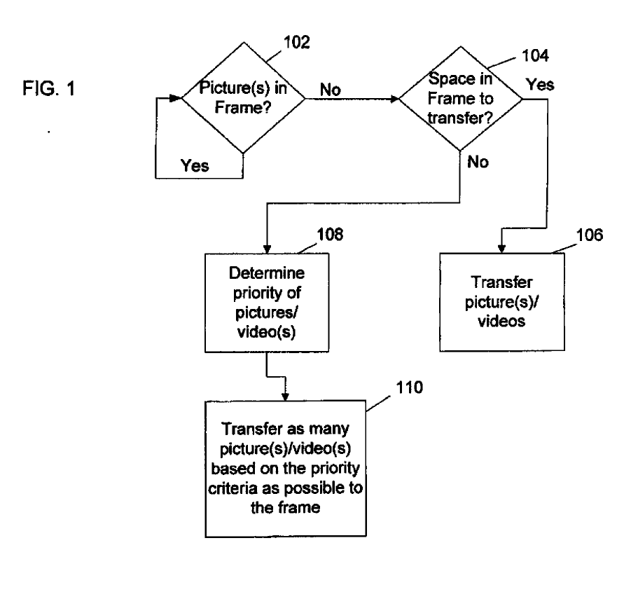

Referring now to the drawings and in particular to FIG. 1, wherein in 102, it is determined if media information such as picture(s)/video(s) are in a display device such as a DPF, if a particular DPF is missing pictures/videos that are in the portable storage device in 104, it is determined if there is room to store the missing information into the that particular DPF. If the DPF has enough storage capacity available to receive the missing information, then in 106 the missing information is stored into the DPF. If in 104 it is determined there is not enough memory capacity in the DPF, in 108 the missing pictures/videos are prioritized using the prioritization criteria set up by the user.

As an illustrative example, the prioritization criteria may be established where the newest (age of data) pictures/videos may be given the highest priority for transfer, followed by the file size (for example the smallest file sizes are prioritized over data that requires larger amounts of storage space). Other prioritization criteria can also include pictures that are grouped together for presentation as a collage in the DPF can take precedence over non-grouped pictures, pictures/videos that associated with audio (i.e., music or voice) can take priority for loading over pictures/videos that have no associated audio.

In 110, the missing pictures/videos are then loaded into the digital picture frame in priority order and as many are loaded as can be stored in the DPF.

As illustrated in the example above, the files in the PC and the one or more digital picture frames are not really “synchronized”, that is differences between source (PC) and destination (digital picture frame(s) are not reconciled in order to make them identical. Transfers depend in one embodiment on available space in both the transfer media (removable storage device) and the target device (digital picture frame(s)), as well as the importance or priority of the files (e.g., pictures, data, video, etc.) to be transferred.

In still another embodiment of the invention, the PC keeps a file listing of what is stored in each of the digital pictures frame(s) of the system and a priority ranking is used to move “missing” files (pictures, etc.) to each of the digital picture frames in the system. This information can be transferred to the PC when the removable storage media is plugged into the PC, since the removable storage media can also keep information (i.e., metadata, etc.) on which pictures/videos have been transferred to which DPFs in the system. In another embodiment, a removable memory device does not have to be used to transfer the information to the PC but the information can be transferred wirelessly to each of the frames in the system and the PC can keep track of what data is stored in each of the frames.

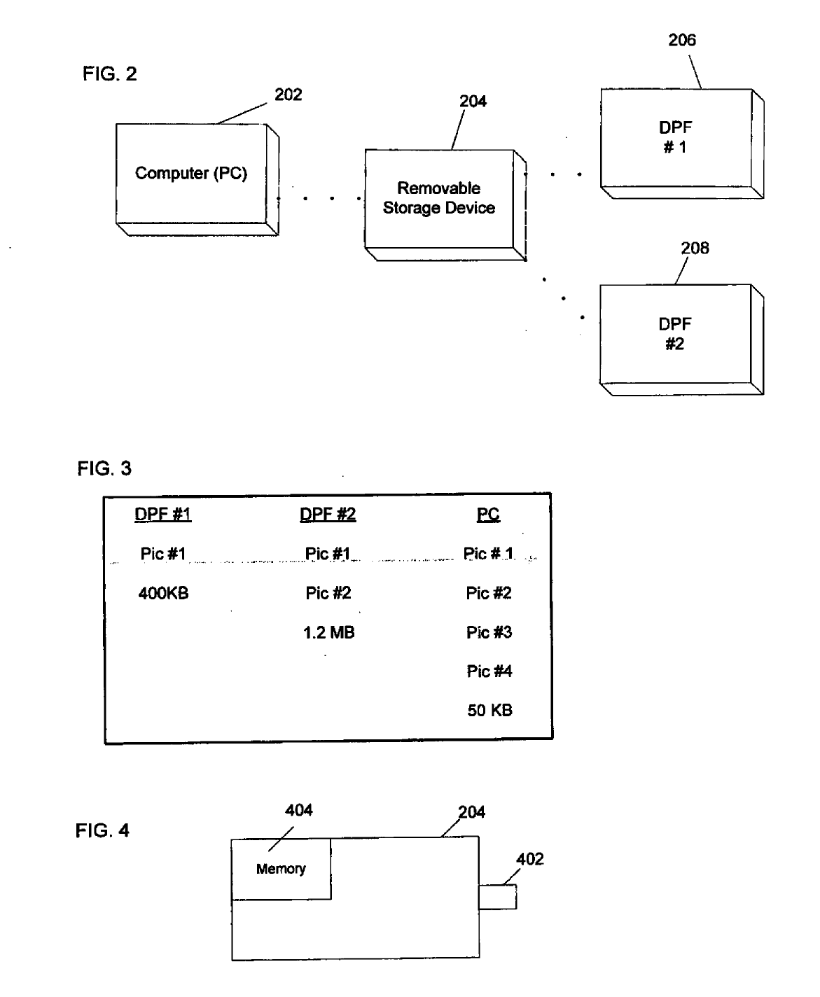

FIG. 2 shows a system including a computer such as a personal computer PC (202), a first digital picture frame (DPF) 206 and a second DPF 208. A removable storage device 204 is used to transfer the information between the PC 202 and DPFs 206 and 208, as previously discussed.

FIG. 3 shows a file stored in the removable storage device 204 and generated by the VF software, showing listings of what is stored in each of the PC, DPF #1 and DPF #2. The listing can also include how much memory storage is available in each of the devices. In this illustrative example, DPF #1 has 400 KB (Kilo-Bytes) of memory available, DPF #2 has 1.2 MB (Mega-Bytes), and the PC has 50 KB. In another embodiment, the system shown in FIG. 2 could be a wireless system wherein the PC 202 communicates with DPF #1 206 and DPF #2 wirelessly using for example IEEE 802.11 wireless standard. In which case, the file shown in FIG. 3 could be stored in the memory of the PC 202 and the PC 202 is the one executing the VF software without the use of the removable storage device 204.

Referring now to FIG. 4, there is shown a diagram of the removable storage medium 204. The removable storage medium includes memory 404 such as Random Access Memory (RAM) and a connector 402 such as a USB connector for use in electrically connecting the removable storage medium to computer 202. The memory 404 can store data files such as media files as well as the management software that includes the prioritization criteria.

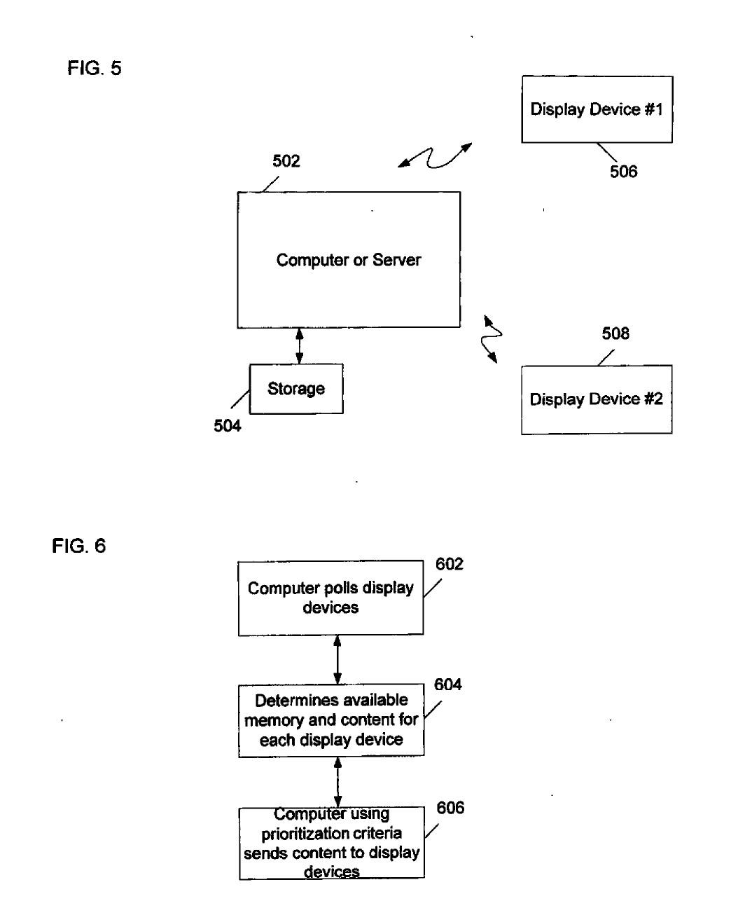

In FIG. 5 there is shown a media management system in accordance with an embodiment of the invention. In this system a computer or server 502 is in communication with a number of display devices such as display device # 1 506 and display device #2 508. The computer or server 502 can use a number of communication technologies such as IEEE 802.11 (WiFi), Bluetooth, Ethernet, etc. to communicate with each other. The computer or server 502 can also be closely located to the display devices (i.e., in the same building) or remotely located to the display devices 506, 508 such as if the computer or server 502 is part of a cloud in a cloud computing environment.

The invention has been described in detail with particular reference to certain preferred embodiments thereof, but it will be understood that variations and modifications can be effected within the spirit and scope of the invention.

1. A removable storage device, comprising:
a memory;
a connector for connecting to an external device; and
a management software stored in the memory including a prioritization criteria for determining which files stored in the memory should be transferred to the external device.

2. A removable storage device as defined in claim 1, wherein the prioritization criteria uses criteria selected from amongst age of file, user rating of file, file size and type of file to determine which files stored in the memory are to be transferred to the external device.

3. A removable storage device as defined in claim 2, wherein the files stored in the memory include media files comprising pictures or videos.

4. A removable storage device as defined in claim 3, wherein the management software causes a file to be stored in the memory which provides information on the file or files stored in the external device.

5. A removable storage device as defined in claim 1, wherein the management software is executed by the external device upon the connector being connected to the external device.

6. A system for media collection management, comprising:
a computer having a storage area having stored therein media files;
first and second display devices in communication with the computer; and
a media management software stored in the storage area including a prioritization criteria for determining which of the media files need to be transferred to the first and second display devices, the prioritization criteria not requiring media file synchronization between the computer and the first and second display devices.

7. A system as defined in claim 6, wherein the computer is wirelessly interconnected with the first and second display devices.

8. A system as defined in claim 6, wherein the first and second display devices include memory for storing media files and the computer polls the first and second display devices to determine how much memory space is available in each of the first and second display devices.

9. A system as defined in claim 8, wherein the computer also polls the first and second display devices to determine what media files are stored in each of the first and second display devices.

10. A system as defined in claim 9, wherein the computer uses the prioritization criteria in association with the memory space available and media files stored in each of the first and second display devices to determine which media files to transfer to each of the first and second display devices.

11. A system as defined in claim 10, wherein the computer comprises a remote server.

12. A method for media collection management between a computer having stored there in media files and a display device, comprising:
using a prioritization criteria for determining which of the media files stored in the computer need to be transferred to the display device; and
transferring to the display device some of the media files that are able to be stored within the display device, the prioritization criteria not requiring media file synchronization between the computer and display device.

13. A method as defined in claim 12, wherein the prioritization criteria includes the age of the media files.

14. A method as defined in claim 12, wherein the prioritization criteria includes the type of media file.

15. A method as defined in claim 12, wherein the prioritization criteria includes the user rating of the media file.

16. A method as defined in claim 12, wherein the prioritization criteria includes determining if the media file had had metadata entered by a user.
